(19) United States
(12) Patent Application Publication
(10) Pub. No.: US 2022/0305587 A1
(43) Pub. Date: Sep. 29, 2022

(54) COMPOSITE PROCESSING METHOD AND DEVICE FOR TEXTURE ON INNER SURFACE OF BEARING SHELL OF RADIAL SLIDING BEARING

(71) Applicant: Jiangsu University, Jiangsu (CN)

(72) Inventors: Zhaoyang ZHANG, Jiangsu (CN); Jian GAO, Jiangsu (CN); Kun XU, Jiangsu (CN); Tao WANG, Jiangsu (CN); Mengnan HU, Jiangsu (CN); Yucheng WU, Jiangsu (CN); Douyan ZHAO, Jiangsu (CN)

(73) Assignee: Jiangsu University, Jiangsu (CN)

(21) Appl. No.: 17/617,922

(22) PCT Filed: Jul. 12, 2021
(86) PCT No.: PCT/CN2021/105775

§ 371 Date: Dec. 9, 2021

(30) Foreign Application Priority Data
Sep. 16, 2020 (CN) 202010973799.8

(51) Int. Cl. B23K 26/352; B23K 26/00; B23P 15/00

(52) U.S. Cl. CPC B23K 26/355; B23K 26/0093; B23P 15/003

(57) ABSTRACT

The present invention provides a composite processing method and device for a texture on an inner surface of a bearing shell of a radial sliding bearing. A surface of a workpiece to be processed is processed by laser to obtain a micron-level texture, an obtained workpiece with the micron-level texture on a surface is placed on a compression device, and the workpiece with the micron-level texture on the surface is subjected to an electro-deposition reaction to obtain a workpiece with a nano-level texture on a surface. The processing device includes an inner spin-printing electrode electrochemical deposition system, a laser irradiation system and a motion control system. The inner spin-printing electrode electrochemical deposition system includes the inner spin-printing electrode, a direct current power supply, the bearing shell and a compression roller.

### TECHNICAL FIELD

The present invention relates to the field of micro machining in special machining technology, and in particular to a composite processing method and device for a texture on an inner surface of a bearing shell of a radial sliding bearing.

### DESCRIPTION OF RELATED ART

Sliding bearings are used in numerous important machinery and equipment, and are key components affecting accuracy, stability, and reliability of equipment. Therefore, the lubrication and friction performance of its load-bearing contact area has been widely concerned by scholars and engineers around the world. At present, great progress has been made in research of wear-resistant coatings, surface textures, lubrication and friction reduction of a bearing shell. The use of a functional surface micro-nano texture to improve the effect of lubrication and friction reduction is becoming an important research direction. Studies have shown that processing the functional micro-nano structure on a surface of the bearing shell can improve its friction reduction and lubrication effect and load-bearing capacity. Therefore, the related research on a manufacturing method and device for the functional surface micro-nano texture of the bearing shell has far-reaching social significance and economic benefits.

At present, scholars around the world have made some progress in the research on processing of the functional surface texture of the bearing shell. “A method for processing an oil-locking self-cleaning structure on a surface of a bearing shell of a sliding bearing” disclosed by Chinese patent publication number CN108506438 A introduces a method for preparing a multi-scale micro-nano structure on the surface of the bearing shell by electrochemical deposition. Although this method can produce multi-scale micro/nano composite structure, and can store and lock lubricating oil and improve the load-bearing capacity of the bearing, but the formation of texture morphology is random and difficult to control. “A method for improving wear resistance and service life of sliding bearings” disclosed by Chinese patent publication number CN1091802730A introduces a method for preparing a micro pit array on a surface of a bearing shell by laser shock. This method can only prepare a millimeter/micron-scale micro-structure, cannot produce a nano-scale micro-structure, and cannot obtain a super-wetting surface.

### SUMMARY

An objective of the present invention is to provide a composite processing method and device for a texture on an inner surface of a bearing shell of a radial sliding bearing in view of deficiencies in the prior art. The method can effectively control morphology and accuracy of the micron-level texture, and can prepare the nano-level texture on the basis of the micron-level texture at the same time, so that the dimensional accuracy, positional accuracy and repeatability accuracy of the overall micro-nano texture are greatly improved compared with the prior art. The present invention further provides a device with which micro-nano texture manufacturing of an inner surface of a bearing shell can be realized.

The present invention is achieved by the following technical solutions.

A composite processing method for a texture on an inner surface of a bearing shell of a radial sliding bearing is provided. A surface of a workpiece to be processed is processed by laser to obtain a micron-level texture, an obtained workpiece with the micron-level texture on a surface is placed on a compression device, and the workpiece with the micron-level texture on the surface is subjected to an electro-deposition reaction to obtain a workpiece with a nano-level texture on a surface.

Further, the method includes the following steps:
programming according to morphology and coverage of a surface texture to be processed, and inputting the programming into control software of a computer;
according to requirements of a scale of the micron-level texture, setting laser parameters and turning on a laser;
running an execution code of a laser etching step, so that a bearing shell to be processed moves as required to etch the micron-level texture that meets the requirements; and
transferring the bearing shell with the micron-level texture etched on an inner surface to the compression device, and pressing an inner spin-printing electrode on the bearing shell, where an electrolyte enters between the inner spin-printing electrode and the bearing shell to form electrochemical deposition conditions, the electro-deposition reaction starts, and during electrochemical deposition, the inner spin-printing electrode and the bearing shell move to generate a bearing shell with the nano-level texture on an inner surface.

Further, the micron-level texture is a pit, groove, cylindrical or conical relief structure.

Further, the nano-level texture is a nanocone, nanopillar or nanotube structure.

Further, a processing device includes an inner spin-printing electrode electrochemical deposition system, a laser irradiation system and a motion control system.
The inner spin-printing electrode electrochemical deposition system includes the inner spin-printing electrode, a direct current power supply, the bearing shell and a compression roller. A positive electrode of the direct current power supply is connected to the bearing shell, and a negative electrode of the direct current power supply is connected to the inner spin-printing electrode. The bearing shell is placed on the compression roller, and the compression roller provides a pre-tightening force to pre-tighten the bearing shell with the inner spin-printing electrode. Liquid-conducting elastomers are arranged on the inner spin-printing electrode, and the electrolyte is drained to an area between the bearing shell and the inner spin-printing electrode through the liquid-conducting elastomers.
The laser irradiation system includes the laser, a reflecting mirror and a focusing lens. The laser emits pulsed laser, the pulsed laser is reflected by the reflecting mirror and then focused by the focusing lens on the inner surface of the bearing shell to be processed.
The motion control system includes the computer, a motion controller, a working platform and a rotating roller set. The computer is connected to the laser, the motion controller and the direct current power supply. The motion controller is used to control work of the working platform, the rotating roller set and the compression roller.

According to the processing device of the composite processing method for a texture on an inner surface of a bearing shell of a radial sliding bearing, the inner spin-printing electrode further include an inner spin-printing electrode body. A liquid-guiding channel is arranged inside the inner spin-printing electrode body. An electrolyte supply tube is connected to the liquid-guiding channel inside the inner spin-printing electrode body. The electrolyte is pumped into the liquid-guiding channel inside the inner spin-printing electrode body through a micro pump, and then enters the liquid-conducting elastomers.

Further, connection between the direct current power supply, the inner spin-printing electrode and the bearing shell is brush connection.

Further, the inner spin-printing electrode body has a ring structure. The liquid-conducting elastomers are evenly distributed on an outer ring of the inner spin-printing electrode body. The liquid-conducting elastomers are in contact with the bearing shell, there is a certain gap between the inner spin-printing electrode body and the bearing shell, and the gap is filled with the electrolyte.

Further, the inner spin-printing electrode drive the bearing shell to rotate, or the shell drive the inner spin-printing electrode to rotate, or the inner spin-printing electrode and the bearing shell each rotate at a set speed.

Further, the working platform is driven to provide displacement of the bearing shell to be processed in an X-Y-Z direction, and the rotating roller set provide motion of the bearing shell in a circumferential direction.

Further, a material of the bearing shell is a conductive material or a non-metallic material with a conductive layer attached to the surface.

The present invention has the following technical advantages and beneficial effects:

1. The inner spin-printing electrode is used to realize preparation of the nano-level texture on the inner surface of the bearing shell.

2. The use of laser etching combined with the electrochemical deposition technology of the inner spin-printing electrode can effectively control the dimensional accuracy, positional accuracy and repeatability accuracy of the micro-nano structure prepared on the inner surface of the bearing shell.

3. The use of laser etching and the electrochemical deposition technology of the inner spin-printing electrode has the advantages of high processing efficiency, good texture surface quality, and high dimensional accuracy.

4. The present invention is used for not only processing of the inner surface of the bearing shell of the radial sliding bearing, but also processing of inner surfaces of tubes, cavities and the like.

5. The present invention first uses a laser etching method to produce the regular micron-level texture on the inner surface of the bearing shell of the radial sliding bearing, and then uses an inner spin-printing electrochemical deposition method to prepare the nano-level texture on the micron-level texture surface. The inner spin-printing electrode in the inner spin-printing electrochemical deposition method has a surface topography self-adaptive function, which does not cause any damage to the micron-level texture while realizing preparation of the nano-texture at a designated position. By processing of the texture on the inner surface of the bearing shell of the radial sliding bearing, super wettability is obtained and the load-bearing capacity of the bearing is improved.

### BRIEF DESCRIPTION OF THE DRAWINGS

FIG. 1 is a schematic diagram of a composite processing device for a texture on an inner surface of a bearing shell of a radial sliding bearing according to an embodiment of the present invention.

Reference numerals in the drawings are as follows:

1—computer; 2—laser; 3—reflecting mirror; 4—focusing lens; 5—motion controller; 6—working platform; 7—rotating roller set; 8—direct current power supply; 9—inner spin-printing electrode; 901—inner spin-printing electrode body; 902—liquid-conducting elastomer; 10—bearing shell; 11—compression roller; 12—filter; 13—micro pump; and 14—electrolyte storage tank.

### DESCRIPTION OF THE EMBODIMENTS

The present invention is further described below with reference to the accompanying drawings and specific implementations. It should be understood that these implementations are only intended to illustrate the present invention and are not intended to limit the scope of the present invention. Modifications of various equivalent forms of the present invention by those skilled in the art after the reading of the present invention fall within the range defined by the appended claims of the present application.

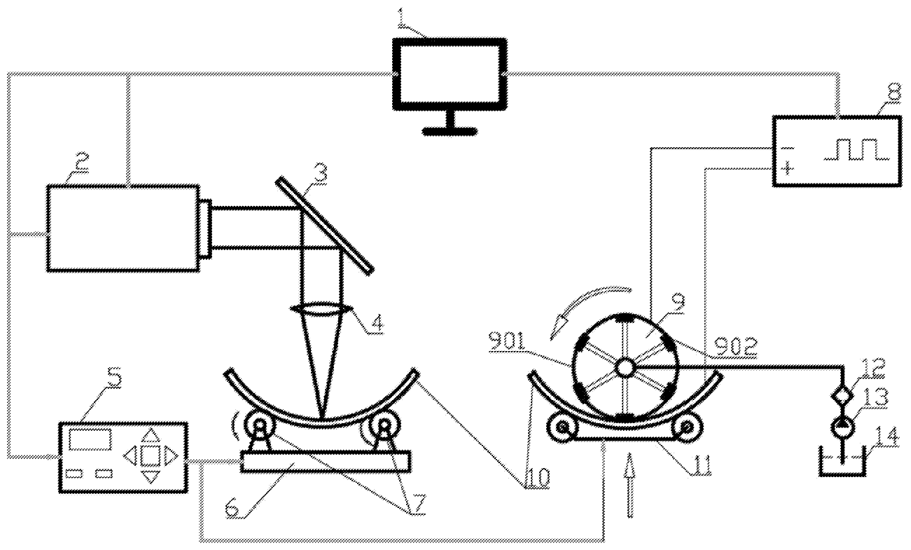

The details and working conditions of the method and device of the present invention will be described in detail below with reference to FIG. 1.

As shown in FIG. 1, a computer 1 is connected to a laser 2, a motion controller 5, and a direct current power supply 8 respectively. The computer 1 can control various parameters of the laser 2, the motion controller 5 and the direct current power supply 8. At the same time, the computer 1 can also use upper computer software to control motion of a working platform 6, a rotating roller set 7 and a compression roller 11 through the motion controller 5.

The rotating roller set 7 is fixed on the working platform 6, and a bearing shell 10 is placed on the rotating roller set 7.

The laser 2 outputs a laser beam, and the laser beam is first reflected by a reflecting mirror 3 and then focused by a focusing lens 4 on an inner surface of the bearing shell 10. The motion controller 5 controls the working platform 6 to move in an X-Y-Z direction, and controls the rotating roller set 7 to rotate, so as to realize etching of a required micron-level texture on the inner surface of the bearing shell 10. Laser parameters and motion parameters of the bearing shell 10 are set according to required texture topography and size.

After laser etching of the previous step, the bearing shell 10 is transferred and placed on a compression roller 11. The motion controller 5 adjusts a pre-tightening force between the bearing shell 10 and an inner spin-printing electrode 9 by controlling a distance between them. The inner spin-printing electrode 9 rotates to drive the bearing shell 10 to rotate, so as to realize electrochemical deposition processing of a designated area on the inner surface of the bearing shell 10.

During an electrochemical deposition reaction, a micro pump 13 draws an electrolyte from an electrolyte storage tank 14, and pumps it into an inner tube of an inner spin-printing electrode body 901 through a filter 12. The electrolyte is introduced into liquid-conducting elastomers 902 through the inner tube and enters an area between the inner spin-printing electrode 9 and the bearing shell 10.

According to a composite processing method and device for a texture on an inner surface of a bearing shell of a radial sliding bearing, through the laser and electrochemical composite processing method, a micro-nano texture is efficiently and accurately prepared on the inner surface of the bearing shell. The specific steps are as follows.

Programming is performed according to morphology and coverage of a surface texture to be processed, and input into control software of the computer 1.

According to requirements of a scale of the micron-level texture, laser parameters are set and the laser 2 is turned on.

An execution code of a laser etching step runs, the computer 1 sends data to the motion controller 5, the motion controller 5 controls the working platform 6 to move in the X-Y-Z direction, and controls the rotating roller set 7 to rotate, so that the bearing shell 10 moves as required to etch the micron-level surface texture that meets the requirements.

The bearing shell 10 with the micron-level texture etched on the inner surface is transferred to the compression roller 11, and the inner spin-printing electrode 9 is pressed on the bearing shell 10, the liquid-conducting elastomers 902 on the inner spin-printing electrode 9 are in contact with the inner surface of the bearing shell 10. The pre-tightening force between the inner spin-printing electrode 9 and the bearing shell 10 is adjusted by adjusting a position of the compression roller 11 relative to the inner spin-printing electrode 9.

The inner spin-printing electrode 9 is connected to a positive electrode of the direct current power supply 8, and the bearing shell 10 is connected to a negative electrode of the direct current power supply 8.

The power supply 8 and the micro pump 13 are turned on. The electrolyte is introduced into the liquid-conducting elastomers 902 through the tube inside the inner spin-printing electrode body 901, and finally injected between the inner spin-printing electrode 9 and the bearing shell 10 to form electrochemical deposition conditions, and an electro-deposition reaction starts to generate a nano-level texture.

During electrochemical deposition, the inner spin-printing electrode 9 rotates to drive the bearing shell 10 to rotate through the pre-tightening force between the liquid-conducting elastomers 902 and the bearing shell 10, so as to realize manufacturing of the nano-level texture at a designated position.

In the description of this specification, the description of “one embodiment”, “some embodiments”, “an example”, “a specific example” and “some examples” means that a specific feature, structure, material or characteristic described in combination with the embodiment(s) or example(s) is included in at least one embodiment or example of the present invention. In this specification, the schematic descriptions of the above terms do not necessarily refer to the same embodiment or example. Moreover, the specific feature, structure, material or characteristic described is combined in any suitable manner in any one or more embodiments or examples.

Although the embodiments of the present invention have been illustrated and described above, it can be understood that the above embodiments are exemplary and cannot be construed as a limitation to the present invention. A person of ordinary skill in the art make various changes, modifications, replacements and variations to the above embodiments without departing from the principle and spirit of the present invention.

1. A composite processing method for a texture on an inner surface of a bearing shell of a radial sliding bearing, wherein a surface of a workpiece to be processed is processed by laser to obtain a micron-level texture, an obtained workpiece with the micron-level texture on a surface is placed on a compression device, and the workpiece with the micron-level texture on the surface is subjected to electrochemical deposition to obtain a workpiece with a nano-level texture on a surface; and the method comprising the following steps:
programming according to morphology and coverage of a surface texture to be processed, and inputting the programming into control software of a computer;
according to requirements of a scale of the micron-level texture, setting laser parameters and turning on a laser; running an execution code of a laser etching step, so that a bearing shell to be processed moves as required to etch the micron-level texture that meets the requirements; and transferring the bearing shell with the micron-level texture etched on an inner surface to the compression device, and pressing an inner spin-printing electrode on the inner surface of the bearing shell, wherein an electrolyte enters between the inner spin-printing electrode and the bearing shell to form electrochemical deposition conditions, an electro-deposition reaction starts, and during electrochemical deposition, the inner spin-printing electrode and the bearing shell move to generate a bearing shell with the nano-level texture on an inner surface,
wherein liquid-conducting elastomers are arranged on the inner spin-printing electrode, and the electrolyte is drained to an area between the bearing shell and the inner spin-printing electrode through the liquid-conducting elastomers, the inner spin-printing electrode further comprises an inner spin-printing electrode body, a liquid-guiding channel is arranged inside the inner spin-printing electrode body, an electrolyte supply tube is connected to the liquid-guiding channel inside the inner spin-printing electrode body, and the electrolyte is pumped into the liquid-guiding channel inside the inner spin-printing electrode body through a micro pump, and then enters the liquid-conducting elastomers.

2. The composite processing method for a texture on an inner surface of a bearing shell of a radial sliding bearing according to claim 1, wherein the micron-level texture is a pit, groove, cylindrical or conical relief structure.

3. The composite processing method for a texture on an inner surface of a bearing shell of a radial sliding bearing according to claim 1, wherein the nano-level texture is a nanocone, nanopillar or nanotube structure.

4. A processing device adopting the composite processing method for a texture on an inner surface of a bearing shell of a radial sliding bearing according to claim 1, the processing device comprising an inner spin-printing electrode electrochemical deposition system, a laser irradiation system and a motion control system, wherein
the inner spin-printing electrode electrochemical deposition system comprises the inner spin-printing electrode, a direct current power supply, the bearing shell and a compression roller; a positive electrode of the direct current power supply is connected to the bearing shell, and a negative electrode of the direct current power supply is connected to the inner spin-printing electrode; the bearing shell is placed on the compression roller, and the compression roller provides a pre-tightening force to pre-tighten the bearing shell with the inner spin-printing electrode;
the laser irradiation system comprises the laser, a reflecting mirror and a focusing lens; the laser emits pulsed laser, and the pulsed laser is reflected by the reflecting mirror and then focused by the focusing lens on the inner surface of the bearing shell to be processed; and
the motion control system comprises the computer, a motion controller, a working platform and a rotating roller set; the computer is connected to the laser, the motion controller and the direct current power supply; and the motion controller is configured to control work of the working platform, the rotating roller set and the compression roller.

5. (canceled)

6. The processing device adopting the composite processing method for a texture on an inner surface of a bearing shell of a radial sliding bearing according to claim 4, wherein connection between the direct current power supply, the inner spin-printing electrode and the bearing shell is brush connection.

7. The processing device adopting the composite processing method for a texture on an inner surface of a bearing shell of a radial sliding bearing according to claim 4, wherein the inner spin-printing electrode body has a ring structure, the liquid-conducting elastomers are evenly distributed on an outer ring of the inner spin-printing electrode body; and the liquid-conducting elastomers are in contact with the bearing shell, a certain gap is defined between the inner spin-printing electrode body and the bearing shell, and the gap is filled with the electrolyte.

8. The processing device adopting the composite processing method for a texture on an inner surface of a bearing shell of a radial sliding bearing according to claim 4, wherein the inner spin-printing electrode drives the bearing shell to rotate, or the shell drives the inner spin-printing electrode to rotate, or the inner spin-printing electrode and the bearing shell each rotate at a set speed.

9. The processing device adopting the composite processing method for a texture on an inner surface of a bearing shell of a radial sliding bearing according to claim 4, wherein the working platform is driven to provide displacement of the bearing shell to be processed in an X-Y-Z direction, and the rotating roller set provides motion of the bearing shell in a circumferential direction; and a material of the bearing shell is a conductive material or a non-metallic material with a conductive layer attached to a surface thereof.
